(19) United States
(12) Patent Application Publication
(10) Pub. No.: US 2026/0184203 A1
(43) Pub. Date: Jul. 2, 2026

(54) TEMPERATURE DETECTION MODULE AND CHARGING DOCK

(71) Applicants: Tyco Electronics (Suzhou) Ltd., Suzhou City (CN); Tyco Electronics (Shanghai) Co., Ltd., Shanghai (CN); Tyco Electronics Technology (SIP) Co., Ltd., Suzhou (CN)

(72) Inventors: Fangyue (Jason) Zhu, Shanghai (CN); Tiancheng Cao, Suzhou (CN); Renyi (Ronny) Dou, Suzhou (CN); Jinshun (Jet) Wang, Suzhou (CN)

(73) Assignees: Tyco Electronics (Suzhou) Ltd., Suzhou City (CN); Tyco Electronics (Shanghai) Co., Ltd., Shanghai (CN); Tyco Electronics Technology (SIP) Co., Ltd., Suzhou (CN)

(21) Appl. No.: 19/435,893

(22) Filed: Dec. 30, 2025

(30) Foreign Application Priority Data
Dec. 31, 2024 (CN) 202411997278.0

(51) Int. Cl. B60L 53/16; G01K 1/14; G01K 1/16; H01R 13/422; H01R 13/506; H01R 13/52; H01R 13/627; H01R 13/66

(52) U.S. Cl. CPC B60L 53/16; G01K 1/14; G01K 1/16; H01R 13/4223; H01R 13/506; H01R 13/5202; H01R 13/6271; H01R 13/6683; H01R 2201/26

(57) ABSTRACT

A temperature detection module includes an insulator, a thermal pad assembled onto the insulator for thermal contact with a power terminal of a charging dock, a temperature sensor provided in the thermal pad to detect a temperature of the power terminal, and a conductive lead provided in the insulator and electrically connected to the temperature sensor. The temperature detection module is installed in a plug-in manner from an outside into an insertion slot formed on a charging dock housing. The thermal pad is in thermal contact with the power terminal when the temperature detection module is installed in the insertion slot to transfer heat from the power terminal to the temperature sensor.

### CROSS-REFERENCE TO RELATED APPLICATION

This application claims the benefit of the filing date under 35 U.S.C. § 119(a)-(d) of Chinese Patent Application No. 202411997278.0, filed on Dec. 31, 2024.

### FIELD OF THE INVENTION

The present invention relates to the field of electric vehicle charging technology, particularly to a temperature detection module and a charging dock comprising the temperature detection module.

### BACKGROUND OF THE INVENTION

In order to charge the battery pack of new energy electric vehicles, it is necessary to install a charging dock suitable for mating with a charging gun on the new energy electric vehicle. In order to improve charging speed, it is necessary to increase the charging current. Currently, the charging current is as high as 600 A, and it may even increase to 1000 A in the future. When a large current flows through the power terminal inside the charging dock, a large amount of heat is generated, which can cause the temperature of the power terminal inside the charging dock to rise sharply. If the temperature rise cannot be controlled in time, it can lead to safety accidents, such as burning the charging dock or other electrical equipment.

In order to control the temperature rise of power terminals, a lead frame is usually installed in the charging dock and a temperature detection module is integrated on the lead frame. The temperature detection module includes a temperature sensor and a thermal pad wrapped around the outside of the temperature sensor. The thermal pad is in thermal contact with the power terminal, and the temperature sensor is electrically connected to the lead frame.

The lead frame, however, generally has a large volume and needs to be pre-installed in the charging dock housing, which is very inconvenient to use. In addition, in order to facilitate the installation of lead frame, the charging dock housing needs to adopt a split design, which leads to a complex structure of the charging dock housing. Further, the existing lead frame needs to be able to rotate between a locking position of locking the power terminal and an unlocking position of unlocking the power terminal, which will make the lead frame and charging dock housing more complex, assembly more difficult, and cost higher.

### SUMMARY OF THE INVENTION

A temperature detection module includes an insulator, a thermal pad assembled onto the insulator for thermal contact with a power terminal of a charging dock, a temperature sensor provided in the thermal pad to detect a temperature of the power terminal, and a conductive lead provided in the insulator and electrically connected to the temperature sensor. The temperature detection module is installed in a plug-in manner from an outside into an insertion slot formed on a charging dock housing. The thermal pad is in thermal contact with the power terminal when the temperature detection module is installed in the insertion slot to transfer heat from the power terminal to the temperature sensor.

### BRIEF DESCRIPTION OF THE DRAWINGS

Features of the present invention will become more apparent by describing in detail exemplary embodiments thereof with reference to the accompanying drawings, in which:

FIG. 1 shows an illustrative perspective view of a temperature detection module according to an exemplary embodiment of the present invention when viewed from one side;

FIG. 2 shows an illustrative exploded view of a temperature detection module according to an exemplary embodiment of the present invention when viewed from one side;

FIG. 3 shows an illustrative exploded view of a temperature detection module according to an exemplary embodiment of the present invention when viewed from the other side;

FIG. 4 shows an illustrative perspective view of a temperature detection module according to an exemplary embodiment of the present invention when viewed from the other side;

FIG. 5 shows an illustrative assembly view of a thermal pad and a temperature sensor of a temperature detection module according to an exemplary embodiment of the present invention;

FIG. 6 shows an illustrative exploded view of the thermal pad and temperature sensor of the temperature detection module according to an exemplary embodiment of the present invention;

FIG. 7 shows an illustrative exploded view of the insulator and conductive leads of a temperature detection module according to an exemplary embodiment of the present invention;

FIG. 8 shows an illustrative view of the electrical connection between the conductive leads of the temperature detection module and the temperature sensor according to an exemplary embodiment of the present invention;

FIG. 9 shows an illustrative perspective view of a temperature detection module according to an exemplary embodiment of the present invention;

FIG. 10 shows an illustrative perspective view of a charging dock according to an exemplary embodiment of the present invention;

FIG. 11 shows an illustrative exploded view of a charging dock according to an exemplary embodiment of the present invention;

FIG. 12 shows an exploded sectional view of a charging dock according to an exemplary embodiment of the present invention; and

FIG. 13 shows an axial sectional view of a charging dock according to an exemplary embodiment of the present invention.

### DETAILED DESCRIPTION

Exemplary embodiments of the present disclosure will be described hereinafter in detail with reference to the attached drawings, wherein like reference numerals refer to like elements. The present disclosure may, however, be embodied in many different forms and should not be construed as being limited to the embodiments set forth herein; rather, these embodiments are provided so that the present disclosure will convey the concept of the disclosure to those skilled in the art.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

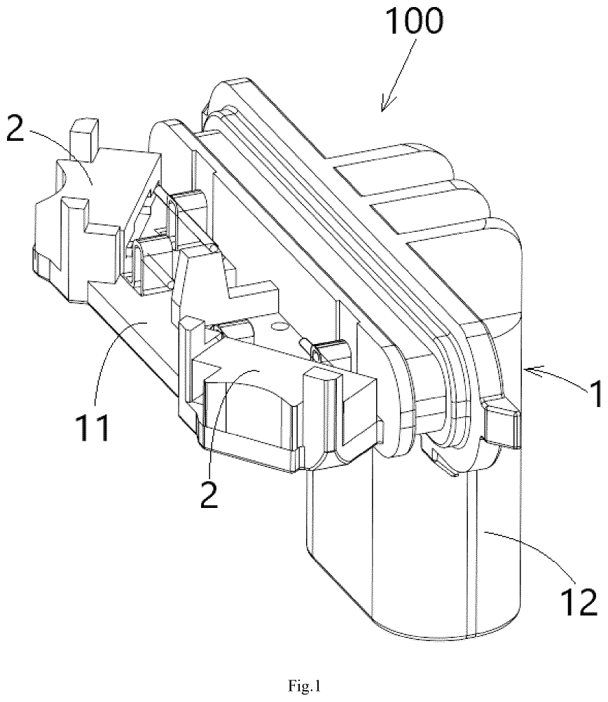

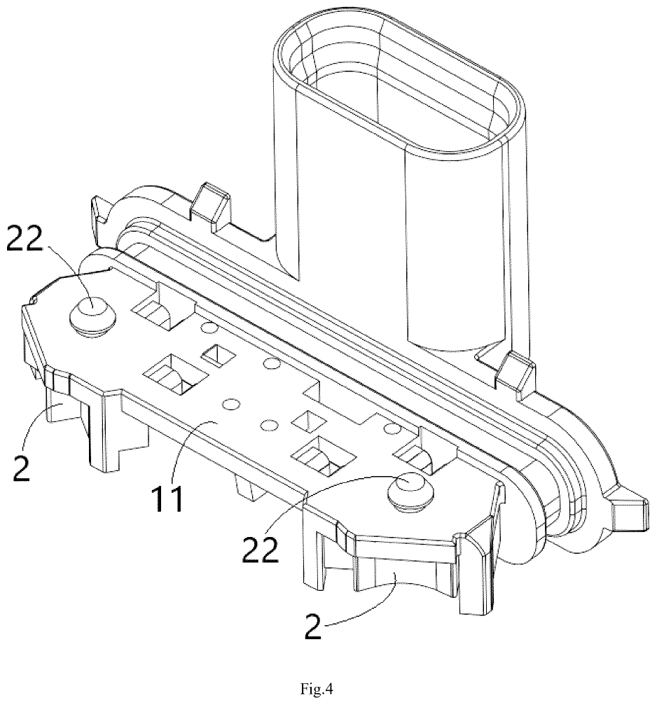

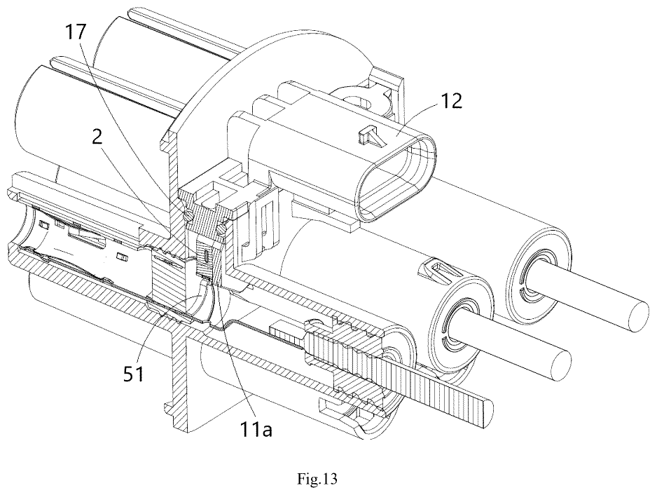

As shown in FIGS. 1 to 9, in an exemplary embodiment of the present invention, a temperature detection module 100 is disclosed. The temperature detection module 100 includes: an insulator 1, a thermal pad 2, a temperature sensor 3, and a conductive lead 4. The thermal pad 2 is assembled onto the insulator 1 for thermal contact with a power terminal 50 (see FIG. 13) of a charging dock. The temperature sensor 3 is installed in the thermal pad 2 to detect the temperature of the power terminal 50. The conductive lead 4 is set in the insulator 1 and electrically connected to the temperature sensor 3.

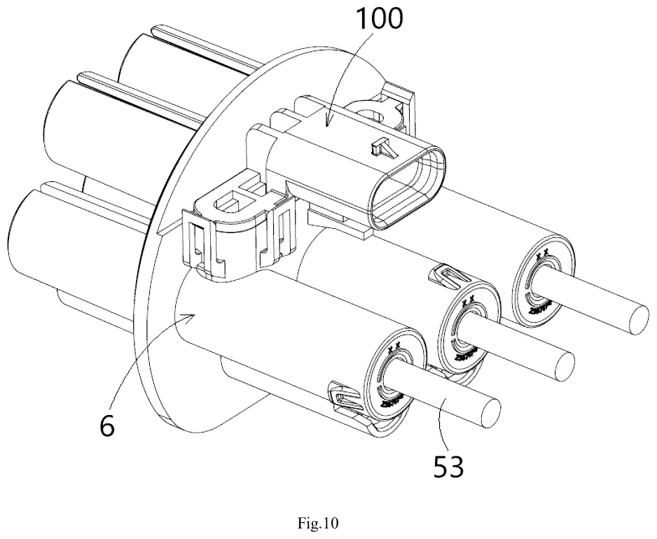

As shown in FIGS. 10 to 13, in the illustrated embodiment, the temperature detection module 100 is adapted to be installed in a pluggable manner from the outside into an insertion slot 62 on a charging dock housing 6. When the temperature detection module 100 is installed in the insertion slot 62, the thermal pad 2 comes into thermal contact with the power terminal 50 to transfer the heat of the power terminal 50 to the temperature sensor 3.

In an embodiment, the insulator 1 is an injection molded part directly injected onto the conductive lead 4, so that the conductive lead 4 and the insulator 1 become an integral piece. However, the present invention is not limited to the illustrated embodiment. For example, in another exemplary embodiment of the present invention, a snap slot is formed on the insulator 1, and the conductive lead 4 is held and fixed in the snap slot on the insulator 1.

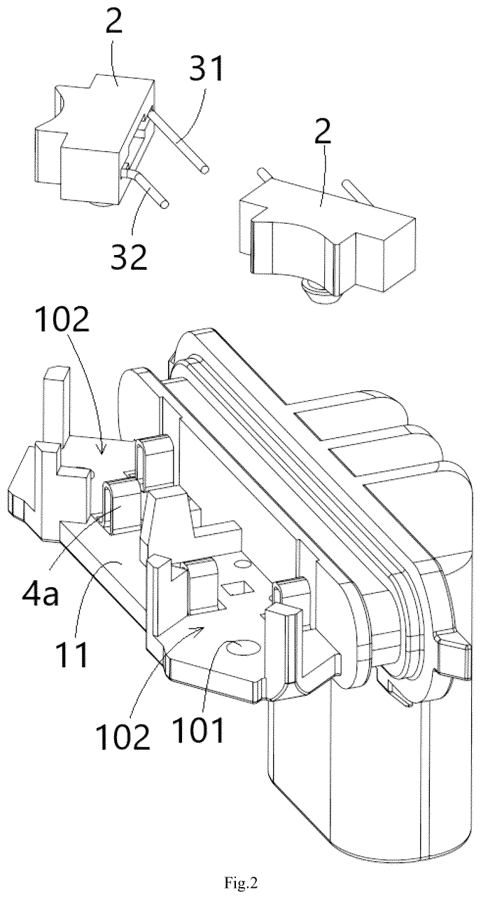

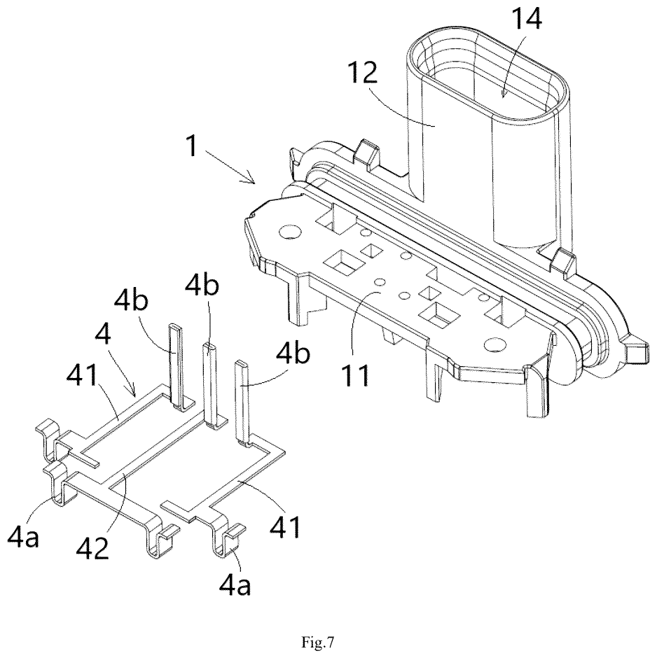

As shown in FIGS. 2 and 7, in the illustrated embodiment, the conductive lead 4 has a connection end 4a for electrical connection with the temperature sensor 3 and an external pin 4b for electrical connection with a connector (not shown) located outside the charging dock housing 6.

As shown in FIGS. 1 to 3, 7, and 9, in the illustrated embodiment, the insulator 1 includes a bracket part 11 and a mating part 12. The bracket part 11 is suitable for inserting into the insertion slot 62 of the charging dock housing 6. The mating part 12 is adapted to be positioned on the outside of the charging dock housing 6, for mating with the connector located on the outside of the charging dock housing 6. The thermal pad 2 and temperature sensor 3 are installed on the bracket part 11, and the mating part 12 has an insertion cavity 14 that allows the connector to be inserted. The external pin 4b of the conductive lead 4 extends into the insertion cavity 14 to electrically connect with the inserted connector.

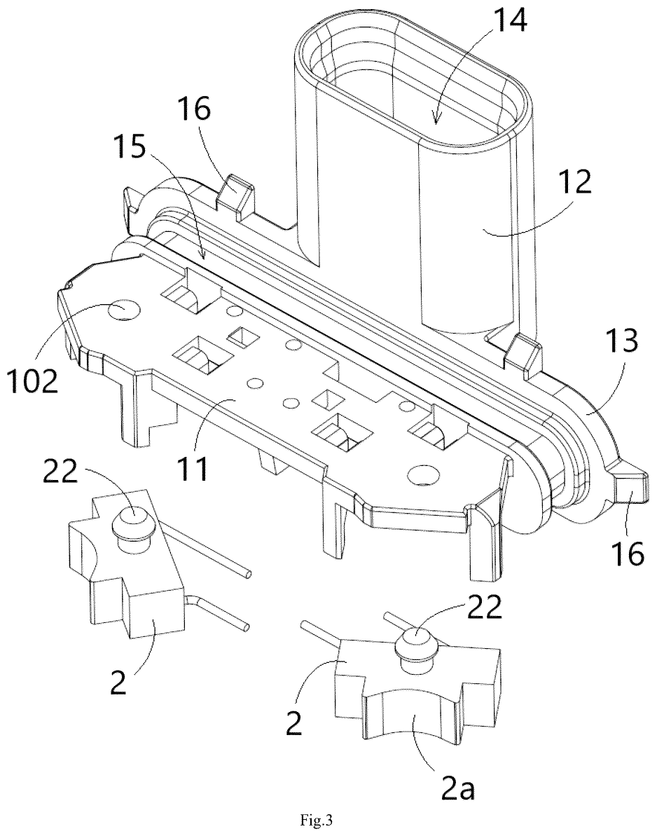

As shown in FIG. 3, in the illustrated embodiment, a sealing ring installation groove 15 is formed on the outer peripheral surface of the bracket part 11. The temperature detection module 100 also includes a sealing ring 17 installed in the sealing ring installation groove 15, which is suitable for being compressed between the bracket part 11 and the inner wall surface of the insertion slot 62 of the charging dock housing 6 to achieve sealing between the two.

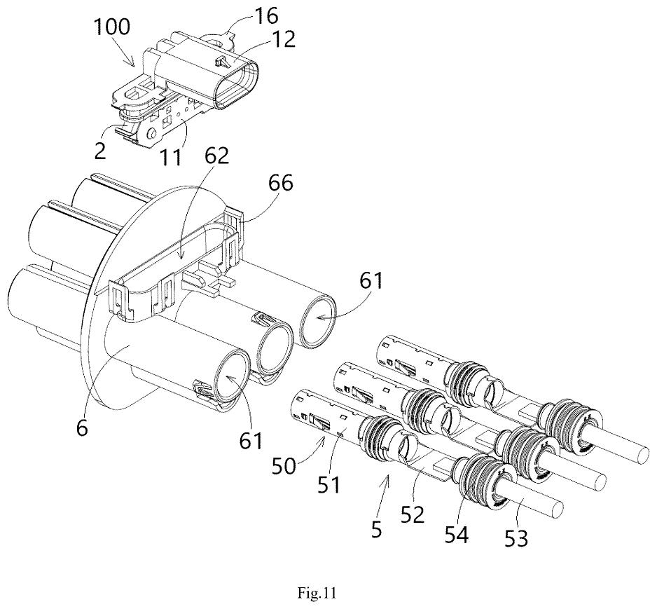

As shown in FIG. 3, in the illustrated embodiment, the bracket part 11 has a cover plate part 13 for covering the entrance of the insertion slot 62 of the charging dock housing 6. Multiple protruding parts 16 are formed on the outer peripheral surface of the cover plate part 13, which are distributed around the outer periphery of the cover plate part 13 and are used to engage with multiple buckles 66 on the charging dock housing 6 shown in FIG. 11, respectively, to lock the temperature detection module 100 into the insertion slot 62 of the charging dock housing 6.

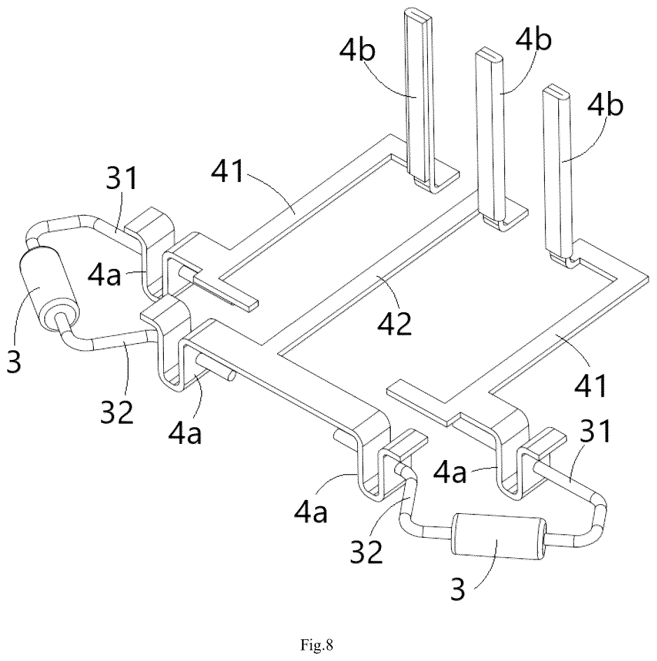

As shown in FIGS. 7 and 8, in the illustrated embodiment, the conductive lead 4 includes a positive lead 41 and a negative lead 42 electrically connected to the positive pin 31 and the negative pin 32 of the temperature sensor 3, respectively. The external pins 4b of the positive lead 41 and the negative lead 42 extend into the insertion cavity 14 of the mating part 12 for electrical connection with the inserted connector.

As shown in FIGS. 7 and 8, in the illustrated embodiment, the connection end 4a of the positive lead 41 is suitable for plug-in electrical connection with the positive pin 31 of the temperature sensor 3. The connection end 4a of the negative lead 42 is suitable for plug-in electrical connection with the negative pin 32 of the temperature sensor 3. However, the present invention is not limited to the illustrated embodiment. For example, the connection end 4a of the positive lead 41 may be welded, crimped, or riveted to the positive pin 31 of the temperature sensor 3. The connection end 4a of the negative lead 42 can be welded, crimped, or riveted to the negative pin 32 of the temperature sensor 3.

In an exemplary embodiment of the present invention, the connection end 4a of the positive lead 41 is in an elastic clip shape, suitable for clamping the positive pin 31 of the temperature sensor 3. The connection end 4a of the negative lead 42 is in an elastic clip shape, suitable for clamping the negative pin 32 of the temperature sensor 3.

As shown in FIGS. 1 to 4, in the illustrated embodiment, the temperature detection module 100 includes multiple thermal pads 2 and multiple temperature sensors 3 respectively arranged in the multiple thermal pads 2. The multiple thermal pads 2 are used to make thermal contact with multiple power terminals 50, and the multiple temperature sensors 3 are used to detect the temperature of the multiple power terminals 50.

As shown in FIG. 7, in the illustrated embodiment, the conductive lead 4 includes multiple positive leads 41 and a single negative lead 42. The connection ends 4a of multiple positive leads 41 are respectively electrically connected to the positive pins 31 of multiple temperature sensors 3, and the single negative lead 42 has multiple connection ends 4a that are respectively electrically connected to the negative pins 32 of multiple temperature sensors 3, as shown in FIG. 8. The external pins 4b of multiple positive leads 41 and the external pins 4b of the single negative lead 42 extend into the insertion cavity 14 of the mating part 12 for electrical connection with the inserted connector.

In another exemplary embodiment of the present invention, the conductive lead 4 includes multiple positive leads 41 and multiple negative leads 42. The connection ends 4a of multiple positive leads 41 are respectively electrically connected to the positive pins 31 of multiple temperature sensors 3, and the connection ends 4a of multiple negative leads 42 are respectively electrically connected to the negative pins 32 of multiple temperature sensors 3. The external pins 4b of multiple positive leads 41 and multiple negative leads 42 extend into the insertion cavity 14 of the mating part 12 for electrical connection with the inserted connector.

As shown in FIG. 2, in the illustrated embodiment, the thermal pad 2 is in the form of a block, and a recessed receiving part 101 is formed on the insulator 1. The thermal pad 2 is positioned and installed in the receiving part 101. A socket 102 is formed in insulator 1, and an elastic buckle 22, shown in FIG. 3, is formed on thermal pad 2 to engage with the socket 102, in order to lock the thermal pad 2 onto insulator 1.

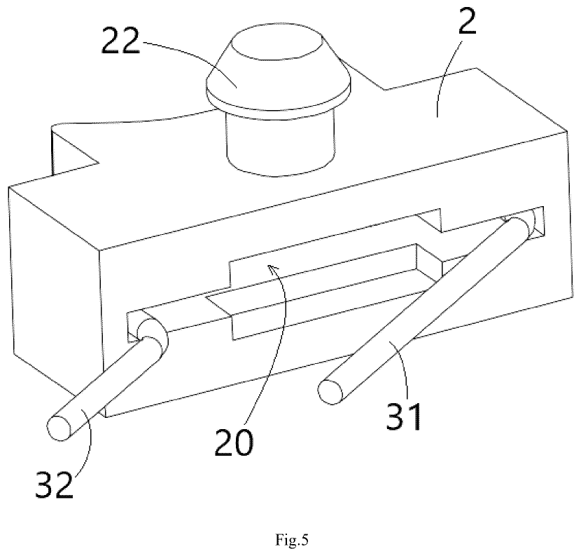

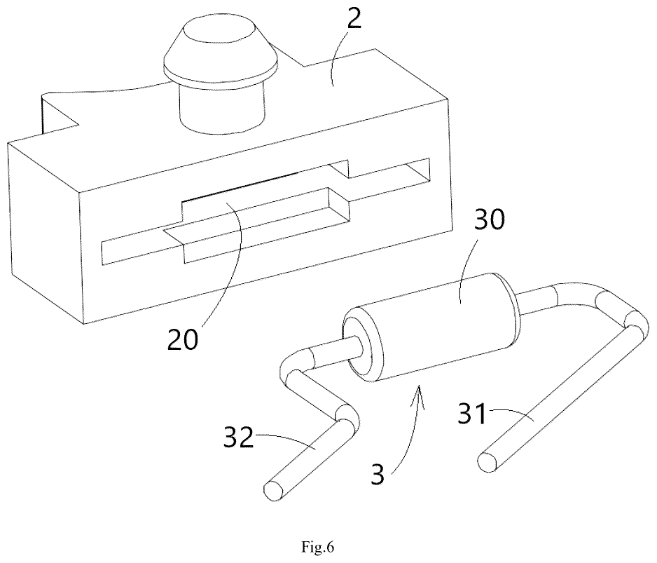

As shown in FIGS. 5 and 6, in the illustrated embodiment, a mounting slot 20 is formed in the thermal pad 2, and the main body 30 of the temperature sensor 3 is inserted into the mounting slot 20 of the thermal pad 2. The positive pin 31 and negative pin 32 of the temperature sensor 3 extend from the thermal pad 2, as shown in FIG. 2. In another exemplary embodiment of the present invention, the thermal pad 2 may be injection molded onto the main body 30 of the temperature sensor 3, so that the thermal pad 2 and the temperature sensor 3 become an integral piece.

As shown in FIG. 3, in the illustrated embodiment, the thermal pad 2 is block shaped and has an arc-shaped contact surface 2a suitable for being attached to the outer peripheral surface of the power terminal 50, in order to increase the thermal contact area between the thermal pad 2 and the power terminal 50.

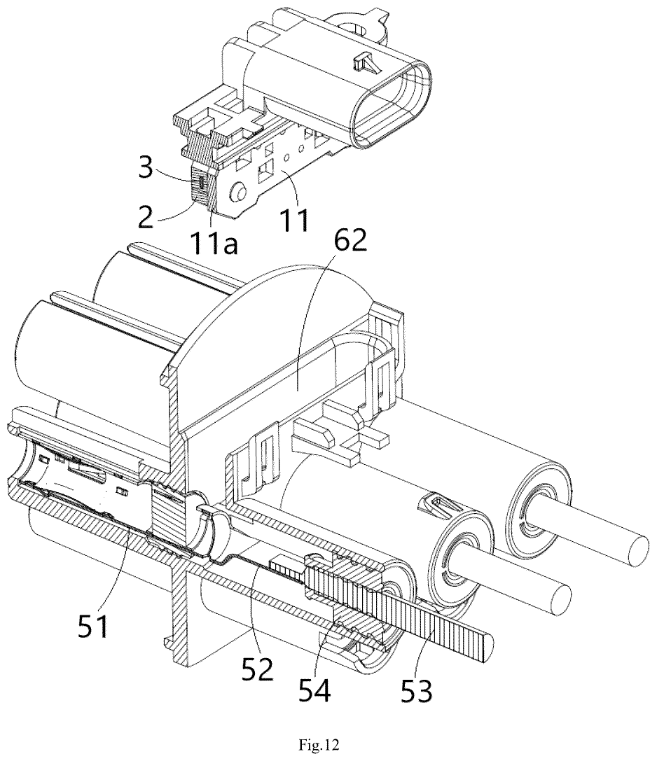

As shown in FIGS. 12 and 13, in the illustrated embodiment, when the temperature detection module 100 is inserted into the insertion slot 62 of the charging dock housing 6, the edge part 11a of the insulator 1 simultaneously presses against the multiple power terminals 50 inside the charging dock housing 6 to lock the multiple power terminals 50 in the charging dock housing 6.

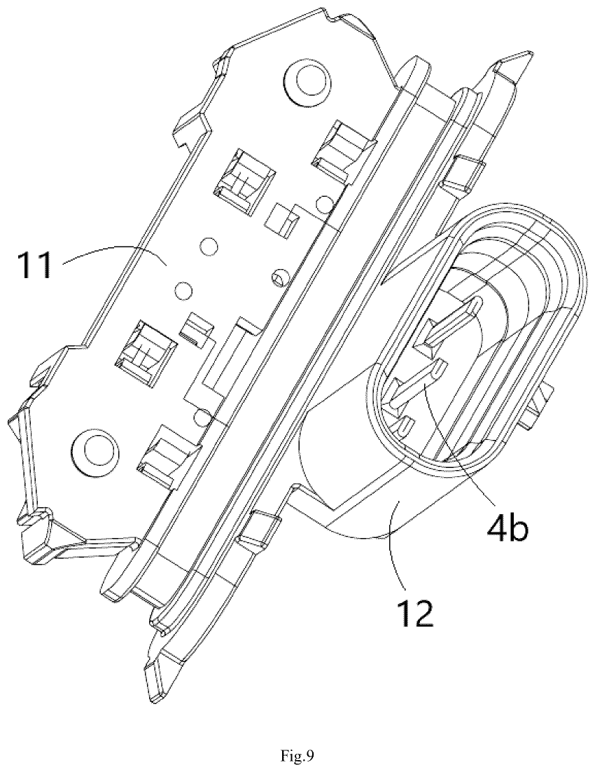

In another exemplary embodiment of the present invention, a charging dock is also disclosed. The charging dock includes, as shown in FIGS. 9 to 13, a charging dock housing 6, a terminal assembly 5, and a temperature detection module 100. The charging dock housing 6 is formed with a terminal socket 102 and an insertion slot 62 communicated with the terminal socket 102. The terminal assembly 5 includes a power terminal 50 and is inserted into the terminal socket 102. The temperature detection module 100 is inserted into the insertion slot 62 from the outside of the charging dock housing 6. The thermal pad 2 of the temperature detection module 100 is in thermal contact with the power terminal 50 to transfer the heat of the power terminal 50 to the temperature sensor 3.

As shown in FIG. 11, in the illustrated embodiment, multiple buckles 66 are formed on the outer side of the peripheral wall of the insertion slot 62 of the charging dock housing 6, and the multiple buckles 66 are distributed around the insertion slot 62 at intervals for respectively engaging with the multiple protruding parts 16 on the insulator 1 of the temperature detection module 100 to lock the temperature detection module 100 in the insertion slot 62.

As shown in FIG. 11, in the illustrated embodiment, the axial direction of insertion slot 62 is perpendicular to the axial direction of terminal socket 102, and the temperature detection module 100 is inserted into insertion slot 62 along the radial direction of the terminal socket 102. In the illustrated embodiment, the cross-section of the insertion slot 62 is elliptical in shape.

As shown in FIG. 11, in the illustrated embodiment, the power terminal 50 includes a cylindrical part 51 and a connection part 52. The cylindrical part 51 is used for mating with a mating power terminal. The connection part 52 is connected to the rear end of the cylindrical part 51 for electrical connection to a cable 53. In the illustrated embodiment, the connection part 52 is flat and welded to the conductor end of the cable 53. The edge part 11a of the insulator 1 of the temperature detection module 100 is axially pressed against the rear end surface of the cylindrical part 51 of the power terminal 50 to lock the power terminal 50 in the terminal socket 102.

As shown in FIGS. 11 and 12, in the illustrated embodiment, the terminal assembly 5 further includes a cable 53 and a sealing plug 54. The cable 53 is electrically connected to the connection part 52 of power terminal 50. The sealing plug 54 is fitted onto the cable 53 and inserted into the rear port of the terminal socket 102. The terminal assembly 5 is inserted through the rear port of the terminal socket 102, and the sealing plug 54 is used to seal the rear port of terminal socket 102.

As shown in FIG. 2, in the illustrated embodiment, the charging dock housing 6 has multiple terminal sockets 102, and the charging dock has multiple terminal assemblies 5 that are respectively inserted into the multiple terminal sockets 102. The insertion slot 62 is communicated with multiple terminal sockets 102, and the temperature detection module 100 includes multiple thermal pads 2 respectively in thermal contact with the power terminals 50 of multiple terminal assemblies 5 and multiple temperature sensors 3 for respectively detecting the temperature of the multiple power terminals 50. In the illustrated embodiment, the edge part 11a of the insulator 1 of the temperature detection module 100 is simultaneously axially pressed against the rear end surfaces of the cylindrical parts 51 of the multiple power terminals 50 to lock the multiple power terminals 50 in the terminal socket 102.

In the illustrated embodiment, the charging dock housing 6 is an integral injection molded part.

In the aforementioned exemplary embodiments according to the present invention, the temperature detection module is not only small in size, but also can be directly inserted into the insertion slot in the charging dock housing from the outside, making its installation and use very convenient.

It should be appreciated for those skilled in this art that the above embodiments are intended to be illustrative, and not restrictive. For example, many modifications may be made to the above embodiments by those skilled in this art, and various features described in different embodiments may be freely combined with each other without conflicting in configuration or principle.

Although several exemplary embodiments have been shown and described, it would be appreciated by those skilled in the art that various changes or modifications may be made in these embodiments without departing from the principles and spirit of the disclosure, the scope of which is defined in the claims and their equivalents.

As used herein, an element recited in the singular and preceded with the word “a” or “an” should be understood as not excluding plural of said elements or steps, unless such exclusion is explicitly stated. Furthermore, references to “one embodiment” of the present invention are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property.

1. A temperature detection module, comprising:
an insulator;
a thermal pad assembled onto the insulator for thermal contact with a power terminal of a charging dock;
a temperature sensor provided in the thermal pad to detect a temperature of the power terminal; and
a conductive lead provided in the insulator and electrically connected to the temperature sensor, the temperature detection module is installed in a plug-in manner from an outside into an insertion slot formed on a charging dock housing, the thermal pad is in thermal contact with the power terminal when the temperature detection module is installed in the insertion slot to transfer heat from the power terminal to the temperature sensor.

2. The temperature detection module according to claim 1, wherein the insulator is an injection molded part directly injected onto the conductive lead, the conductive lead and the insulator become an integral piece.

3. The temperature detection module according to claim 1, wherein a snap slot is formed on the insulator, the conductive lead is clamped and fixed in the snap slot on the insulator.

4. The temperature detection module according to claim 1, wherein the conductive lead has a connection end electrically connected to the temperature sensor and an external pin for electrical connection with a connector located outside the charging dock housing.

5. The temperature detection module according to claim 4, wherein the insulator includes a bracket part insertable into the insertion slot of the charging dock housing and a mating part positioned outside the charging dock housing, the thermal pad and the temperature sensor are installed on the bracket part, the mating part has an insertion cavity receiving the connector, the external pin of the conductive lead extends into the insertion cavity to be electrically connected to the connector.

6. The temperature detection module according to claim 5, wherein a sealing ring installation groove is formed on an outer peripheral surface of the bracket part, and further comprising a sealing ring installed in the sealing ring installation groove, the sealing ring is compressed between the bracket part and an inner wall surface of the insertion slot of the charging dock housing to achieve sealing between the bracket part and the charging dock housing.

7. The temperature detection module according to claim 5, wherein the bracket part has a cover plate part covering an entrance of the insertion slot of the charging dock housing, and a plurality of protruding parts are formed on an outer peripheral surface of the cover plate part, the protruding parts are distributed around an outer periphery of the cover plate part and respectively engage with a plurality of buckles on the charging dock housing to lock the temperature detection module into the insertion slot of the charging dock housing.

8. The temperature detection module according to claim 5, wherein the conductive lead has a positive lead and a negative lead electrically connected to a positive pin and a negative pin of the temperature sensor, respectively, the external pins of the positive lead and the negative lead extend into the insertion cavity of the mating part for electrical connection with the connector.

9. The temperature detection module according to claim 8, wherein:
a connection end of the positive lead is suitable for plug-in electrical connection with the positive pin of the temperature sensor; and/or
a connection end of the negative lead is suitable for plug-in electrical connection with the negative pin of the temperature sensor.

10. The temperature detection module according to claim 9, wherein:
the connection end of the positive lead is in an elastic clip shape and clamps the positive pin of the temperature sensor; and/or
the connection end of the negative lead is in an elastic clip shape and clamps the negative pin of the temperature sensor.

11. The temperature detection module according to claim 5, wherein the thermal pad is one of a plurality of thermal pads and the temperature sensor is one of a plurality of temperature sensors, each of the temperature sensors is arranged on one of the thermal pads, the thermal pads each thermally contact one of a plurality of power terminals and the temperature sensors detect a temperature of each of the power terminals.

12. The temperature detection module according to claim 11, wherein the conductive lead has a plurality of positive leads and a single negative lead, a plurality of connection ends of the positive leads are respectively electrically connected to a plurality of positive pins of the temperature sensors, and the single negative lead has a plurality of connection ends respectively electrically connected to a plurality of negative pins of the temperature sensors, a plurality of external pins of the positive leads and a plurality of external pins of the single negative lead extend into the insertion cavity of the mating part for electrical connection with the connector.

13. The temperature detection module according to claim 11, wherein the conductive lead has a plurality of positive leads and a plurality of negative leads, a plurality of connection ends of the positive leads are respectively electrically connected to a plurality of positive pins of the temperature sensors, and a plurality of connection ends of the negative leads are respectively electrically connected to a plurality of negative pins of the temperature sensors, a plurality of external pins of the positive leads and a plurality of external pins of the negative leads extend into the insertion cavity of the mating part for electrical connection with the connector.

14. The temperature detection module according to claim 1, wherein the thermal pad is block shaped, and a recessed receiving part is formed on the insulator, the thermal pad is positioned and installed into the recessed receiving part, a socket is formed in the insulator, and an elastic buckle that engages with the socket is formed on the thermal pad to lock the thermal pad onto the insulator.

15. The temperature detection module according to claim 1, wherein a mounting slot is formed in the thermal pad, a main body of the temperature sensor is inserted into the mounting slot of the thermal pad, a positive pin and a negative pin of the temperature sensor extend from the thermal pad.

16. The temperature detection module according to claim 1, wherein the thermal pad is injection molded onto a main body of the temperature sensor, the thermal pad and the temperature sensor are an integral piece.

17. The temperature detection module according to claim 1, wherein the thermal pad is block shaped and has an arc-shaped contact surface attachable to an outer peripheral surface of the power terminal to increase a thermal contact area between the thermal pad and the power terminal.

18. The temperature detection module according to claim 1, wherein, when the temperature detection module is inserted into the insertion slot of the charging dock housing, an edge part of the insulator is pressed against the power terminal inside the charging dock housing to lock the power terminal in the charging dock housing.

19. A charging dock, comprising:
a charging dock housing formed with a terminal socket and an insertion slot communicated with the terminal socket;
a terminal assembly including a power terminal and inserted into the terminal socket; and
a temperature detection module inserted from an outside of the charging dock housing into the insertion slot, the temperature detection module includes an insulator, a thermal pad assembled onto the insulator, a temperature sensor provided in the thermal pad to detect a temperature of the power terminal, and a conductive lead provided in the insulator and electrically connected to the temperature sensor, the thermal pad is in thermal contact with the power terminal when the temperature detection module is installed in the insertion slot to transfer heat from the power terminal to the temperature sensor.

20. The charging dock according to claim 19, wherein a plurality of buckles are formed on an outer side of a peripheral wall of the insertion slot of the charging dock housing, the buckles are distributed around the insertion slot at intervals for respectively engaging with a plurality of protruding parts on the insulator of the temperature detection module to lock the temperature detection module in the insertion slot.

21. The charging dock according to claim 19, wherein an axial direction of the insertion slot is perpendicular to an axial direction of the terminal socket, the temperature detection module is inserted into the insertion slot along a radial direction of the terminal socket.

22. The charging dock according to claim 21, wherein the power terminal includes a cylindrical part used for mating with a mating power terminal and a connection part connected to a rear end of the cylindrical part for electrical connection to a cable, an edge part of the insulator of the temperature detection module is axially pressed against a rear end surface of the cylindrical part of the power terminal to lock the power terminal in the terminal socket.

23. The charging dock according to claim 22, wherein the terminal assembly includes:
a cable electrically connected to the connection part of the power terminal; and
a sealing plug fitted onto the cable and inserted into a rear port of the terminal socket, the terminal assembly is inserted through the rear port of the terminal socket and the sealing plug seals the rear port of the terminal socket.

24. The charging dock according to claim 19, wherein the terminal socket is one of a plurality of terminal sockets of the charging dock housing and the terminal assembly is one of a plurality of terminal assemblies of the charging dock, the terminal assemblies are respectively inserted into the terminal sockets, the insertion slot is communicated with the terminal sockets, the thermal pad is one of a plurality of thermal pads of the temperature detection module and the temperature sensor is one of a plurality of temperature sensors of the temperature detection module, the thermal pads are in thermal contact with the power terminals of the terminal assemblies and the temperature sensors to detect a temperature of the power terminals.

25. The charging dock according to claim 19, wherein the charging dock housing is an integral injection molded part.
